(19) United States
(12) Patent Application Publication
(10) Pub. No.: US 2009/0068498 A1
(43) Pub. Date: Mar. 12, 2009

(54) MATERIAL OF CERAMIC SUBSTRATE FOR THIN-FILM MAGNETIC HEAD

(75) Inventors: Hidetaka Sakumichi, Osaka (JP); Shinzoh Mitomi, Fukuoka (JP)

Correspondence Address: HITACHI METALS, LTD.;C/O KEATING & BENNETT, LLP, 1800 Alexander Bell Drive, SUITE 200, Reston, VA, 20191, US

(73) Assignees: HITACHI METALS, LTD., Minato-ku, Tokyo (JP); NIPPON TUNGSTEN CO., LTD., Fukuoka-shi, Fukuoka (JP)

(21) Appl. No.: 11/912,004

(22) PCT Filed: Apr. 7, 2006
(86) PCT No.: PCT/JP2006/307470

§ 371 Date: Oct. 19, 2007

(30) Foreign Application Priority Data
Apr. 21, 2005 (JP) 2005-124216

(51) Int. Cl. G11B 5/33; B28B 3/02

(52) U.S. Cl. 428/815.1; 264/319

(57) ABSTRACT

A ceramic substrate material has good thermal conductivity and machinability, which are high enough to apply it to thin-film magnetic heads, and low particle generation. A ceramic substrate material for a thin-film magnetic head includes 25 vol % to 70 vol % of WC and the balance consisting essentially of Al₂O₃. The WC includes at most 0.1 mass % of a metal, at most 0.5 mass % of oxygen and at most 0.5 mass % of nitrogen. And the WC has a mean particle size of 0.6 μm or less.

### BACKGROUND OF THE INVENTION

1. Field of the Invention

The present invention relates to a ceramic substrate material for use to make a thin-film magnetic head slider for a hard disk drive.

2. Description of the Related Art

Thanks to recent tremendous development of information and telecommunication technologies, the amount of information that can be processed by computers has increased by leaps and bounds. In particular, audiovisual (or multimedia) information such as audio, music and video, which used to be capable of being processed only as analog signals, now can be converted into digital signals and processed by personal computers. Multimedia data such as music and video contains a huge amount of information. Thus, it has become more and more necessary to further increase the capacity of information storage devices for use in personal computers, for example.

A hard disk drive is a typical information storage device that has been used extensively in personal computers, for example. To meet the demand described above, the capacity of hard disks needs to be further increased and the overall size of the drive needs to be reduced.

An Al₂O₃—TiC (which will be abbreviated herein as “AlTiC”) based ceramic is known as a material for a thin-film magnetic head ceramic substrate for a hard disk drive. AlTiC includes Al₂O₃ as a first phase and TiC as a second phase, has good thermal conductivity and is suitable for precision machining, too. For these reasons, almost all thin-film magnetic heads are made of AlTiC in conventional hard disk drives.

As the demands for hard disk drives of a smaller size are further growing, however, it has become more and more necessary to provide a ceramic substrate material that has better thermal conductivity, and can be machined more precisely, than AlTiC for thin-film magnetic heads.

Examples of materials with high thermal conductivity include Al₂O₃—SiC based ceramics and Al₂O₃—TiB2—TiC based ceramics. However, the particles dispersed in these ceramics are too hard to apply them to a thin-film magnetic head that should have been machined finely and precisely and that should have a highly smooth machined surface.

Another material with high thermal conductivity is an Al₂O₃—WC based ceramic, which is obtained by adding WC to Al₂O₃ (see Patent Documents Nos. 1 to 4, for example). The Al₂O₃—WC based ceramic includes Al₂O₃ particles and WC particles with almost the same hardness, and therefore, has generally good machinability.

Specifically, Patent Document No. 1 discloses an Al₂O₃—WC based ceramic consisting essentially of 10 vol % to 90 vol % of WC, which has higher thermal conductivity than Al₂O₃, and Al₂O₃ as the balance. In order to further increase the strength and toughness of the Al₂O₃—WC based ceramic disclosed in Patent Document No. 1, Patent Document No. 2 discloses a WC—Al₂O₃ based composite sintered body obtained by adding 0.5 wt % to 2.0 wt % of MgO to the ceramic of Patent Document No. 1. Patent Document No. 3 discloses an Al₂O₃—WC based ceramic that has had its toughness and hardness further increased by adding not just WC but also a predetermined amount of W2C. And in order to increase the oxidation resistance and abrasion resistance of the Al₂O₃—WC based ceramic disclosed in Patent Document No. 3, Patent Document No. 4 discloses a surface coated ceramic, of which the surface is coated with a Group IVa element or a compound of Al.

Patent Document No. 1: Japanese Patent Application Laid-Open Publication No. 3-290355

Patent Document No. 2: Japanese Patent Application Laid-Open Publication No. 6-9264

Patent Document No. 3: Japanese Patent Application Laid-Open Publication No. 5-279121

Patent Document No. 4: Japanese Patent Application Laid-Open Publication No. 6-340481

As can be seen, various techniques have been proposed to improve the properties of Al₂O₃—WC based ceramics. To apply an Al₂O₃—WC based ceramic to thin-film magnetic heads, however, the thermal conductivity and machinability thereof need to be further improved.

Also, once fine particles have been deposited on the surface of a magnetic head, the head can no longer read or write information accurately. That is why a ceramic substrate material for thin-film magnetic heads also needs to stir up as little dust as possible, i.e., should have low particle generation.

### SUMMARY OF THE INVENTION

In order to overcome the problems described above, preferred embodiments of the present invention provide a ceramic substrate material with good thermal conductivity and machinability, which are high enough to apply it to thin-film magnetic heads, and low particle generation.

A ceramic substrate material for a thin-film magnetic head according to a preferred embodiment of the present invention includes 25 vol % to 70 vol % of WC and the balance consisting essentially of Al₂O₃. The WC includes at most 0.1 mass % of a metal, at most 0.5 mass % of oxygen and at most 0.5 mass % of nitrogen. And the WC has a mean particle size of 0.6 μm or less.

In one preferred embodiment, the metal is at least one element selected from the group consisting of Ti, V, Cr, Mn, Fe, Co, Ni, Zr, Nb and Mo and is present either as a solid solution, or as a carbide or an oxide of the metal, in the WC.

A substrate according to another preferred embodiment of the present invention is made of any of the ceramic substrate materials described above.

A thin-film magnetic head slider according to a preferred embodiment of the present invention includes a substrate made of any of the ceramic substrate materials described above, and a read device and a write device, which are held on the substrate.

A hard disk drive according to a preferred embodiment of the present invention includes the thin-film magnetic head slider described above.

A method of making any of the ceramic substrate materials described above includes the steps of mixing WC powder with a mean particle size of 0.6 μm or less and Al₂O₃ powder together, thereby obtaining a mixture of the WC and Al₂O₃ powders, and sintering the mixture by a hot pressing process, a hot isostatic pressing process or a combination thereof.

A ceramic substrate material according to a preferred embodiment of the present invention has good thermal conductivity and machinability and low particle generation, too, and therefore, can be used effectively to make a ceramic substrate for a thin-film magnetic head in a hard disk drive with high storage density.

Other features, elements, processes, steps, characteristics and advantages of the present invention will become more apparent from the following detailed description of preferred embodiments of the present invention with reference to the attached drawings.

### BRIEF DESCRIPTION OF DRAWINGS

FIG. 1 is a graph showing a correlation between the mean particle size of a WC powder and the particle generation in Experimental Example No. 2.

FIG. 2 is a graph showing a correlation between the volume percentage of WC in an Al₂O₃—WC based ceramic and the particle generation in Experimental Example No. 2.

FIG. 3 is a graph showing correlations between the volume percentage of WC and the volume resistivity and between the mean particle size of a WC powder and the volume resistivity in Experimental Example No. 3.

### DETAILED DESCRIPTION OF PREFERRED EMBODIMENTS

To provide a better material to make a ceramic substrate for thin-film magnetic heads, the present inventors carried out researches on Al₂O₃—WC based ceramics. As a result, the present inventors discovered that by using an Al₂O₃—WC based ceramic including a predetermined amount of WC with a small mean particle size and with a reduced percentage of impurities, the thermal conductivity and machinability could both improved, and the amount of dust stirred up could be reduced, as compared to using AlTiC, thus acquiring the basic idea of the present invention.

First, the components of a ceramic substrate material for thin-film magnetic heads according to preferred embodiments of the present invention will be described.

WC for use in the present invention has a mean particle size of 0.6 μm or less. By using WC with such a small mean particle size, the amount of dust stirred up can be reduced (see Experimental Example #2 to be described later). In addition, a high surface roughness Ra of approximately 1 nm, which is required in near-contact magnetic head substrates, for example, is also realized. To minimize the particle generation and increase the surface roughness, WC preferably has as small a mean particle size as possible, e.g., 0.3 μm or less. The lower limit of the preferred mean particle size range of WC is not particularly set from the standpoint of particle generation but should be approximately 0.05 μm, considering the handiness, press compactibility and cost of preparing the powder.

As used herein, the mean particle size refers to a 50 vol % size of a particle size distribution that is obtained using a particle size distribution measuring system (product name: Micro Track HRA) by laser diffraction scattering method.

WC includes at most 0.1 mass % of a metal, at most 0.5 mass % of oxygen and at most 0.5 mass % of nitrogen. By reducing the amounts of impurities contained in WC in this manner, the thermal conductivity can be further increased (see Experimental Example #1 to be described later). The metal is at least one element selected from the group consisting of Ti, V, Cr, Mn, Fe, Co, Ni, Zr, Nb and Mo. These metals are inevitably contained in the process step of making a WC powder, for example, and are usually present either as solid solutions or as metal carbides in WC. However, those metals may sometimes be included as metal oxides in WC. The contents of these impurities are as small as possible. And the metals, oxygen, and nitrogen included in WC are preferably 0.01 mass % or less, 0.1 mass % or less, and 0.1 mass % or less, respectively. To increase the thermal conductivity, however, the lower limits of the contents of these impurities are not particularly set. The contents of these impurities are preferably as small as possible and may even be 0 mass %.

The contents of these metals are measured with an inductively coupled plasma (ICP) analyzer. The contents of oxygen and nitrogen are measured with an oxygen-nitrogen simultaneous analyzer (in which oxygen is analyzed by infrared absorption method and nitrogen is analyzed by thermal conductivity method).

WC preferably accounts for 25 vol % to 70 vol % of the ceramic of the present invention. If WC accounted for less than 25 vol %, the thermal conductivity would decrease (see Experimental Examples #1 and 3 to be described later). To increase the thermal conductivity, the WC percentage is preferably as high as possible. However, even if more than 70 vol % of WC were added, the function described above would only be saturated and the cost would just increase. More preferably, WC accounts for 30 vol % to 50 vol % of the ceramic.

The ceramic substrate material of preferred embodiments of the present invention includes WC that satisfies the requirements described above and the balance consists essentially of Al₂O₃. According to various preferred embodiments of the present invention, the properties of Al₂O₃ used are not particularly limited as long as Al₂O₃ is normally included in an Al₂O₃—WC based ceramic material. For example, if Al₂O₃ including 90 vol % or more of crystalline α phase and having a mean particle size of about 5 μm or less is used, the sinterability can be improved. Al₂O₃ preferably has a mean particle size of 1 μm or less.

The ceramic of preferred embodiments of the present invention may have a binary composition consisting essentially of WC and Al₂O₃. However, unless the functions of preferred embodiments of the present invention are interfered with, some other ingredients, which are usually included in an Al₂O₃—WC based ceramic material, may be further added to improve the mechanical and other properties of the ceramic. Examples of those non-Al₂O₃ ingredients to be contained in the balance include oxides of Mg, Si, Ca, Zr, Cr, Y, Er and Yb and their composites. These additives combined preferably account for at most 1.0 mass % of the entire ceramic substrate material.

Hereinafter, a method of making a ceramic substrate material according to a preferred embodiment of the present invention will be described.

First, a WC powder with a mean particle size of 0.6 μm or less is provided. Such a WC powder with a small mean particle size may be obtained by mechanically pulverizing a coarse WC powder with a ball mill, for example. Alternatively, such a WC powder may also be obtained either by adjusting the particle sizes of the metal W and oxides of W or by controlling the manufacturing conditions while the WC powder is being made.

Next, Al₂O₃ powder is added to, and mixed with, the WC powder such that the WC powder accounts for 25 vol % to 70 vol % of the entire ceramic. If the particle sizes of the WC powder are adjusted with a ball mill, the WC powder may have its particle sizes adjusted either before being, or after having been, mixed with the Al₂O₃ powder.

Thereafter, the resultant powder mixture is sintered by either hot pressing (HP) or hot isostatic pressing (HIP), thereby obtaining a desired sintered body. Alternatively, the sintering process may also be carried out as a combination of hot pressing and hot isostatic pressing.

In the hot pressing process, for example, the sintering process is preferably carried out for approximately 30 to 300 minutes at a temperature of about 1,400° C. to about 1,800° C. and a pressure of about 10 MPa to about 50 MPa with the sintering atmosphere controlled to be an inert atmosphere or a vacuum. On the other hand, in the hot isostatic pressing process, the sintering process is preferably carried out for approximately 30 to 300 minutes at a temperature of about 1,400° C. to about 1,800° C. and a pressure of about 100 MPa to about 2,000 MPa with the sintering atmosphere controlled to be an inert atmosphere.

### Experimental Example 1

In this experimental example, Al₂O₃—WC based ceramics having different WC volume percentages and different mean particle sizes were made as specific examples of the present invention (represented by Samples #2 through #7) and comparative examples (represented by Samples #8 through #12) as shown in the following Table 1 to see how their thermal conductivities and mechanical properties changed. Sample #1 represents a conventional Al₂O₃—TiC ceramic and was used for the purpose of comparison.

TABLE 1

| | | | Amount of impurities | | | Mean particle |
|---|---|---|---|---|---|---|
| Sample | Al₂O₃ | WC | (mass %) in WC | | | size (μm) |
| No. | (vol %) | (vol %) | Metal | Oxygen | Nitrogen | of WC |
| 1* | — | | — | — | — | 1.00 |
| 2 | 75 | 25 | 0.01 | 0.3 | 0.1 | 0.42 |
| 3 | 70 | 30 | 0.01 | 0.3 | 0.1 | 0.39 |
| 4 | 60 | 40 | 0.01 | 0.3 | 0.1 | 0.39 |
| 5 | 50 | 50 | 0.01 | 0.3 | 0.1 | 0.40 |
| 6 | 40 | 60 | 0.01 | 0.3 | 0.1 | 0.43 |
| 7 | 30 | 70 | 0.01 | 0.3 | 0.1 | 0.50 |
| 8 | 80 | 20 | 0.01 | 0.3 | 0.1 | 0.46 |
| 9 | 70 | 30 | 0.50 | 0.3 | 0.1 | 0.40 |
| 10 | 70 | 30 | 0.01 | 1.2 | 0.1 | 0.45 |
| 11 | 70 | 30 | 0.01 | 0.3 | 1.5 | 0.38 |
| 12 | 70 | 30 | 0.01 | 0.3 | 0.1 | 1.20 |

*Sample #1 used 70% Al₂O₃—30% TiC

The ceramics representing specific examples of preferred embodiments of the present invention and comparative examples were made in the following manner.

First, Al₂O₃ powder with a mean particle size of about 0.5 μm and any of the WC powders shown in Table 1 are provided. The amounts of impurities included in the WC powder were adjusted by controlling the manufacturing conditions of the WC powder. The mean particle size of the WC powder was adjusted by pulverizing a coarse WC powder having a mean particle size of about 1.5 μm with a ball mill for various amounts of time.

Next, the WC powder and the Al₂O₃ powder were weighed so as to have the mixing ratio shown in Table 1, wet-mixed together in a ball mill for approximately 40 hours, and then dried with a spray drier, thereby obtaining a granulated powder. And this granulated powder was sintered by performing a hot pressing process for approximately 60 to 120 minutes at a temperature of about 1,400° C. to about 1,800° C. and a pressure of about 20 MPa within an Ar gas atmosphere. In this manner, a ceramic was obtained.

The ceramics representing specific examples of preferred embodiments of the present invention, comparative examples and a prior art example (Sample #1), which had been obtained as described above, had their various properties measured. In the properties shown in Table 2, the thermal conductivity was measured by the laser flash method compliant with JIS R1611, the fracture toughness was measured by a method compliant with JIS R1607, the Young's modulus was measured by the three point bending method compliant with JIS R1602, and the flexural strength was measured by a three point bending test compliant with JIS R1610. The abrasion efficiencies of the respective ceramics were evaluated by getting the rate of abrasion per 20 minutes, which was carried out using single crystal diamond powder with a mean particle size of 0.5 μm, measured with a linear gauge. In this case, the abrasion efficiencies were evaluated as relative values with respect to that of the prior art example (Sample #1) that was supposed to have an efficiency of 100.

The results are shown in the following Table 2:

TABLE 2

| | Thermal | Fracture | Young's | Flexural | |
|---|---|---|---|---|---|
| Sample | conductivity | toughness | modulus | strength | Lapping |
| No. | (W/m · K) | (MPa) | (GPa) | (MPa) | rate* |
| 1 | 23 | 3.8 | 420 | 880 | 100 |
| 2 | 26 | 4.8 | 460 | 920 | 190 |
| 3 | 32 | 5.2 | 490 | 1050 | 220 |
| 4 | 35 | 5.3 | 510 | 1080 | 230 |
| 5 | 38 | 5.3 | 540 | 1020 | 230 |
| 6 | 44 | 5.2 | 550 | 1100 | 210 |
| 7 | 48 | 5.2 | 600 | 1060 | 205 |
| 8 | 21 | 4.2 | 430 | 890 | 160 |
| 9 | 23 | 5.2 | 490 | 920 | 220 |
| 10 | 24 | 5.3 | 480 | 1020 | 220 |
| 11 | 23 | 4.9 | 490 | 940 | 190 |
| 12 | 33 | 4.9 | 490 | 980 | 180 |

*Lapping rate is expressed as a ratio to that of Sample #1, which is supposed to be 100.

Samples #2 through #7 representing specific examples of the present invention all had thermal conductivities of 26 W/m·K or more. The higher the volume percentage of WC, the higher the thermal conductivity. The abrasion efficiencies were approximately twice as high as that of AlTiC ceramics. Thus, it can be seen that the machinability improved significantly. Also, their flexural strength and fracture toughness were high enough to apply those materials to thin-film magnetic heads without causing any problem in practice.

In contrast, Sample #8 representing a comparative example with a low WC volume percentage and Samples #9, #10 and #11 representing comparative examples including a lot of metal, a lot of oxygen, and a lot of nitrogen, respectively, in WC had thermal conductivities of 21 W/m·K to 24 W/m·K, which were lower than those of the specific examples of the present invention. In these comparative examples, the mean particle sizes of the WC powders were almost equal to those of the specific examples of the present invention but the thermal conductivities decreased. That is why it can be seen that to increase the thermal conductivity, it is important to appropriately control the volume percentage of WC and the amounts of impurities included in WC.

In Sample #8 representing a comparative example with a low WC volume percentage, not only the thermal conductivity but also the fracture toughness and Young's modulus decreased.

It was confirmed that Sample #12 representing a comparative example in which the WC powder had as large a mean particle size as 1.20 μm exhibited thermal conductivity, flexural strength and other properties that were as good as those of specific examples of the present invention but had deteriorated particle generation as shown in Table 1. The relation between the mean particle size of the WC powder and the amount of dust scattered will be described in detail later on Experimental Example No. 3.

### Experimental Example 2

In this experimental example, Al₂O₃—WC based ceramics with various WC volume percentages and mean particle sizes were made as Samples #21 through #27 as shown in Table 3 to find how much the particle generation changed with these parameters. Samples #21, #22 and #23 used WC powders in which the volume percentage ratio of Al₂O₃ to WC was fixed at 75% to 25% but which had mutually different mean particle sizes. Samples #21 and #22 represent specific examples of preferred embodiments of the present invention, while Sample #23 represents a comparative example. On the other hand, Samples #24 through #27 used WC powders, which had the same mean particle size of 0.2 μm but in which the volume percentage ratios of Al₂O₃ to WC were different from each other. Samples #24 and #25 represent comparative examples, while Samples #26 and #27 represent specific examples of the present invention.

These ceramics were made in the following manner.

First, as in Experimental Example No. 1, Al₂O₃ powder with a mean particle size of 0.5 μm and various WC powders shown in Table 3 were provided. Every sample contained the same amount of impurities in WC. Specifically, WC included 0.01 mass % of metal, 0.3 mass % of oxygen, and 0.1 mass % of nitrogen.

Next, the WC powders thus obtained and the Al₂O₃ powder were weighed so as to have the mixture ratios shown in Table 3, mixed together as in Experimental Example No. 1, and then sintered by being sequentially subjected to a hot pressing process and a hot isostatic pressing process under the conditions shown in Table 4.

The particle generation properties of these ceramics representing specific examples of the present invention and comparative examples were evaluated. More specifically, the particle generation was determined by immersing a bar-shaped sample (with dimensions of approximately 50 mm×1.2 mm×0.4 mm) in ultra-pure water, cleaning the sample with ultrasonic waves of 68 kHz for one minute, and then counting the number of particles (with mean particle sizes of approximately 0.5 μm or more) in the cleaning liquid with a laser particle counter (LPC). The same cleaning operation was repeatedly performed five times in total. In this test, if the number of particles in the cleaning liquid was 30,000 or less after the cleaning operation was carried out for the first time, the sample was evaluated as having “good particle generation”.

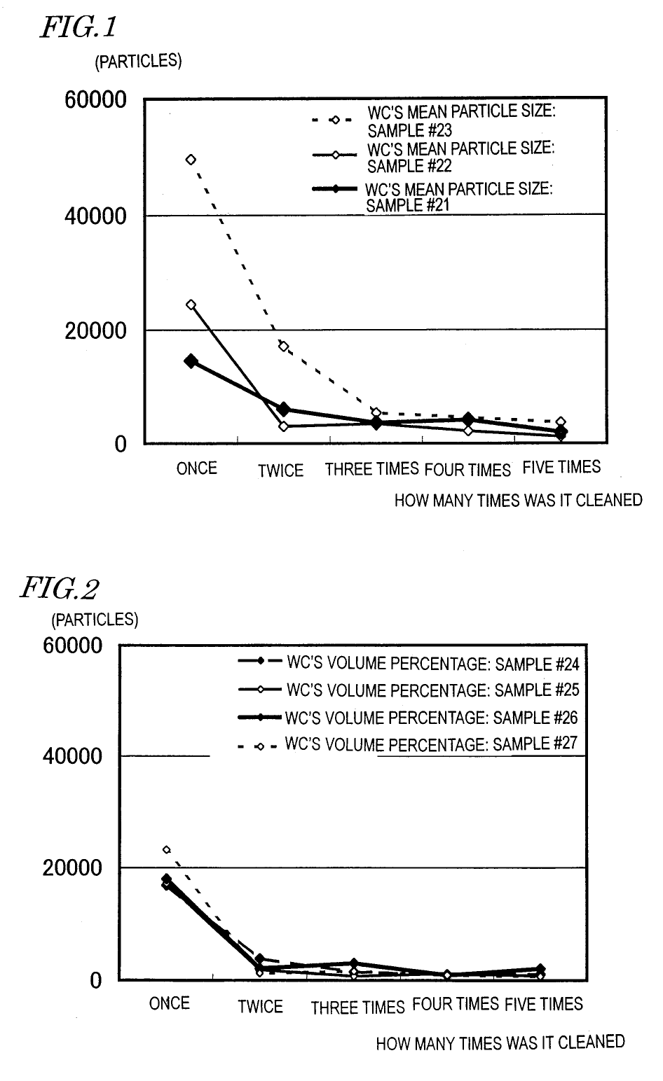

These results are also shown in Table 4. Furthermore, the particle generation properties of Samples #21, #22 and #23 are shown in FIG. 1 and those of Samples #24 through #27 are shown in FIG. 2.

TABLE 3

| Sample | Al₂O₃ | WC | Mean particle |
|---|---|---|---|
| No. | (vol %) | (vol %) | size (μm) of WC |
| 21 | 75 | 25 | 0.2 |
| 22 | 75 | 25 | 0.6 |
| 23 | 75 | 25 | 1.5 |
| 24 | 90 | 10 | 0.2 |
| 25 | 80 | 20 | 0.2 |
| 26 | 70 | 30 | 0.2 |
| 27 | 60 | 40 | 0.2 |

TABLE 4

| | | |
|---|---|---|
| HP | Temperature | 1,500° C. to 1,800° C. |
| | Pressure | 10 MPa to 30 MPa |
| | Atmosphere | Ar gas |
| | Process time | 60 min to 120 min |
| HIP | Temperature | 1,300° C. to 1,400° C. |
| | Pressure | 50 MPa to 200 MPa |
| | Atmosphere | Ar gas |
| | Process time | 60 min to 120 min |

As shown in FIG. 1, in Samples #21 and #22 representing specific examples of preferred embodiments of the present invention in which WC powders with small mean particle sizes of 0.6 μm and 0.2 μm were used, the number of particles in the cleaning liquid could be reduced to less than 30,000 by performing the cleaning operation only once. The particle generation of Sample #21 with a smaller WC mean particle size is superior to that of Sample #22. On the other hand, Sample #23 representing a comparative example that used a WC powder with a mean particle size of 1.5 μm scattered an increased amount of dust. Thus, it can be seen that the mean particle size of WC powder is an important factor to minimize particle generation.

It was also discovered that when a WC powder with a mean particle size of 0.6 μm was used, the amounts of dust scattered could be reduced to approximately the same low level even if the volume percentage of WC was changed within the range of 10% to 40% as in Samples #24 through #27 (see FIG. 2).

### Experimental Example 3

In this experimental example, Al₂O₃—WC based ceramics with various WC volume percentages and various mean particle sizes were made as in Experimental Example No. 1 as shown in Table 5 to find how much the volume resistivity changed with these parameters. Every sample contained the same amount of impurities in WC. Specifically, WC included 0.01 mass % of metal, 0.3 mass % of oxygen, and 0.1 mass % of nitrogen.

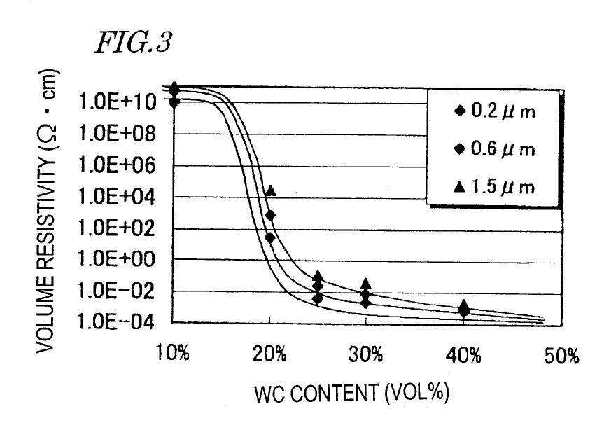

The volume resistivities of the ceramics thus obtained were measured by a four-terminal, four-probe method. The results are also shown in Table 5. Also, FIG. 3 shows how the volume resistivity changed with the volume percentage of WC and the mean particle size of the WC powder.

TABLE 5

| WC content | Mean particle size of WC | | |
|---|---|---|---|
| (vol %) | 0.2 μm | 0.6 μm | 1.5 μm |
| 10 | 1.0E+10 | 5.0E+10 | 1.0E+11 |
| 20 | 3.0E+01 | 8.0E+02 | 3.0E+04 |
| 25 | 4.0E−03 | 2.4E−02 | 1.2E−01 |
| 30 | 2.2E−03 | 8.0E−03 | 4.0E−02 |
| 40 | 7.0E−04 | 1.0E−03 | 2.0E−03 |

As shown in FIG. 3, the volume resistivities of the Al₂O₃—WC based ceramics started to decrease significantly when WC had a volume percentage of approximately 25%. And once the volume percentage of WC exceeded 25%, the volume resistivities of the Al₂O₃—WC based ceramics were roughly 0.12 Ω·cm or less. Even if such a ceramic is used as material for a magnetic head slider, the problem of static electricity never happens and sufficiently high conductivity is realized.

As described above, preferred embodiments of the present invention provide a ceramic that has higher thermal conductivity and machinability than AlTiC and that can minimize particle generation. Thus, the ceramic of the present invention can be used effectively as a material for a magnetic head slider for a high storage density HDD. That is to say, by using a magnetic head slider made of the ceramic substrate material of the present invention, a high reliability, high storage density HDD can be obtained. It should be noted that a method of making a magnetic head slider using the ceramic substrate material of preferred embodiments of the present invention and a method of making an HDD using the slider could be carried out by known processes, and the description thereof will be omitted herein.

Preferred embodiments of the present invention provide a ceramic substrate material for thin-film magnetic heads for use in a thin-film magnetic head slider of a hard disk drive.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-6. (canceled)

7. A ceramic substrate material for a thin-film magnetic head, the material comprising 25 vol % to 70 vol % of WC and the balance consisting essentially of Al₂O₃,
wherein the WC includes at most 0.1 mass % of a metal, at most 0.5 mass % of oxygen and at most 0.5 mass % of nitrogen, and
wherein the WC has a mean particle size of 0.6 μm or less.

8. The ceramic substrate material of claim 7, wherein the metal is at least one element selected from the group consisting of Ti, V, Cr, Mn, Fe, Co, Ni, Zr, Nb and Mo and is present either as a solid solution, or as a carbide or an oxide of the metal, in the WC.

9. A substrate made of the ceramic substrate material of claim 7.

10. A thin-film magnetic head slider comprising:
a substrate made of the ceramic substrate material of claim 7; and
a read device and a write device, which are held on the substrate.

11. A hard disk drive comprising the thin-film magnetic head slider of claim 10.

12. A method of making the ceramic substrate material of claim 7, the method comprising the steps of:
mixing WC powder with a mean particle size of 0.6 μm or less and Al₂O₃ powder together, thereby obtaining a mixture of the WC and Al₂O₃ powders; and
sintering the mixture by a hot pressing process, a hot isostatic pressing process or a combination thereof.
